(19) United States
(12) Patent Application Publication
(10) Pub. No.: US 2009/0113505 A1
(43) Pub. Date: Apr. 30, 2009

(54) SYSTEMS, METHODS AND COMPUTER PRODUCTS FOR MULTI-USER ACCESS FOR INTEGRATED VIDEO

(75) Inventor: Ke Yu, Alpharetta, GA (US)

Correspondence Address: AT&T Legal Department - CC;Attn: Patent Docketing, Room 2A-207, One AT&T Way, Bedminster, NJ, 07921, US

(73) Assignee: AT&T BLS INTELLECTUAL PROPERTY, INC., Wilmington, DE (US)

(21) Appl. No.: 11/925,386

(22) Filed: Oct. 26, 2007

(51) Int. Cl. H04N 7/173

(52) U.S. Cl. 725/114

(57) ABSTRACT

A method, system and computer program product for delivering continuous integrated video via an IPTV network are provided. Input is received from multiple cameras, where each camera is focused on a portion of a larger scene and captures its portion of the larger scene. Memory of a video processor stores each camera's captured portion of the larger scene. The video processor and a buffer memory execute a process for merging each camera's captured portion of the larger scene into a continuous integrated video that is stored in a memory of a video server. The video server and a set-top box communicate via the IPTV network. The video server receives inputs from the set-top box operated by a subscriber for viewing specific portions of the integrated video. The requested portion of the integrated video is streamed from the buffer memory to the set-top box.

### BACKGROUND OF THE INVENTION

1. Field of the Invention

Exemplary embodiments relate to the field of network communication transmissions, and particularly to the field of network communication transmissions within networks that support Internet protocol television services.

2. Description of Background

Internet protocol television (IPTV) is a digital television delivery service wherein the digital television signal is delivered to residential users via a computer network infrastructure using the Internet Protocol. Typically, IPTV services are bundled with additional Internet services such as Internet web access and voice over Internet protocol (VOIP). Subscribers receive IPTV services via a set-top box that is connected to a television or display device for the reception of a digital signal. Used in conjunction with an IP-based platform, the set-top box allows for a subscriber to access IPTV services and any additional services that are integrated within the IPTV service.

IPTV service platforms allow for an increase in the interactive services that can be provided to residential subscribers. As such, a subscriber can have access to a wide variety of content that is available via the IPTV service or the Internet. For example, a subscriber may utilize interactive services via a set top box to view IPTV content or access their personal electronic messaging accounts via an Internet web browser. The IPTV infrastructure also allows the delivery of a variety of video content instantly to the subscribers.

In previous generation cable and satellite based television delivery systems, the subscriber is limited to the views of the scenes provided by the director of a particular television program. Therefore, every subscriber receives the same images of a scene from the same perspective during playback. Previous generation television systems were incapable of providing a subscriber the ability to view a video scene from their desired perspective. For example, subscribers viewing a live basketball game on television ill view the same images in the same sequence as other subscribers. Previous generation systems do not provide a means for an individual subscriber to view a different scene from the scene viewed by other subscribers.

Subscribers may want to view video scenes from desired perspectives. For example, subscribers viewing a live basketball ball game may want to view the game from the perspective of sitting at center court. Other subscribers may want to view the game from overhead, capturing the entire basketball court. Still other viewers may wish to view the game from the perspective of sitting behind their home team's basketball goal. Still other subscribers may wish to zoom in or out on a particular player. There may be a desire by a subscriber to pan or tilt a particular scene. However, current television delivery systems only allow subscribers to view the game from one perspective, which is that of the television show producer.

### SUMMARY

Exemplary embodiments include a method for distributing a continuous integrated video to multiple subscribers via an IPTV network. Input is received from multiple cameras, where each camera is focused on a portion of a larger scene and each camera captures its portion of the larger scene. Memory of a video processor stores each camera's captured portion of the larger scene. The video processor and a buffer memory execute a process for merging each camera's captured portion of the larger scene into a continuous integrated video. The continuous integrated video is stored in a memory of a video server. The video server and a set-top box communicate via the IPTV network, and the set-top box is operable over the IPTV network. The set-top box is connected to a display device and operated by a subscriber. The video server receives inputs from the set-top box operated by the subscriber for viewing specific portions of the integrated video. The requested portion of the integrated video is streamed from the buffer memory to the set-top box in accordance with the subscriber's inputs.

Additional exemplary embodiments include a system for providing a continuous integrated video via an IPTV network. A video processor receives inputs from multiple cameras, and each camera is focused on a portion of a scene and each camera captures its portion of the scene. The video processor has a memory for storing each camera's captured portion of the scene. The video processor is operative to merge each camera's captured portion of the scene into the continuous integrated video, such that the continuous integrated video contains the entire scene and stores the continuous integrated video in a buffer memory. A video server connected to the memory of the video processor, and the video server is operative to receive inputs from a set-top box for viewing specific portions of the continuous integrated video and to stream the requested portion of the continuous integrated video from the memory to the set-top box in accordance with the received inputs.

Further exemplary embodiments include a computer program product that includes a computer readable medium having stored therein a sequence of instructions which, when executed by a processor, causes the processor to deliver continuous integrated video via an IPTV network to a display device. Multiple images captured by a sequence of video cameras are received, and the multiple images include multiple portions of a panoramic scene in a field-of-view of the sequence of video cameras. The multiple images captured by the sequence of video cameras are processed so that the multiple images are merged into a continuous integrated video that provides the panoramic scene in the field-of-view of the sequence of video cameras. The merged continuous integrated video is processed to allow a virtual pan, a tilt, and/or a zoom of a portion of the merged continuous integrated video. The normal, pan, tilt, and/or zoom portion of the merged continuous integrated video is streamed in accordance with signals received from a set-top box.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The foregoing and other objects, features, and advantages of the invention are apparent from the following detailed description taken in connection with the accompanying drawings in which:

FIG. 1 illustrates an exemplary embodiment of an IPTV network providing multi-user access of integrated video to a subscriber in an IPTV environment.

FIG. 2 illustrates aspects of a system for capturing a scene using multiple cameras that may be implemented within exemplary embodiments.

FIG. 3 illustrates aspects of a process for merging multiple captured portions of a scene into one integrated scene that may be implemented within exemplary embodiments.

FIG. 4 illustrates aspects of the multi-user access of the integrated scene that may be implemented within exemplary embodiments.

FIG. 5 is an exemplary flow diagram detailing aspects of a methodology for merging multiple digital images in an IPTV environment.

FIG. 6 illustrates an example of a video processor server processing a plurality of portions in accordance with exemplary embodiments.

The detailed description explains the exemplary embodiments, together with advantages and features, by way of example with reference to the drawings.

### DETAILED DESCRIPTION OF EXEMPLARY EMBODIMENTS

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

Embodiments include systems and methods for using multiple cameras to capture portions of an entire scene. For example, foul digital video cameras may be used, each focused on an individual quarter section of a basketball court during a basketball game. The embodiments herein include systems and methods wherein the images captured by each camera are merged together to form one continuous scene, or in this example, one complete video of the entire basketball ball court. Once those images are merged together, multiple users accessing the integrated video system within an IPTV environment can manipulate the continuous scene, such that each individual user can view the portion of the scene which that user wishes to see. The system further allows individual users to virtually pan, tilt and zoom the particular scene that they are viewing within the IPTV environment.

In exemplary embodiments, an IPTV gateway interfaces with a video processor that processes images from multiple cameras focused on a particular scene such that the entire field of view of the scene can be captured and directed to an IPTV subscriber. Additionally, the gateway interfaces with an IP Multimedia Subsystem (IMS) component that is responsible for handling the performance preferences for an IPTV system as dictated by the desires of an IPTV subscriber, according to exemplary embodiments. Further, the IPTV gateway may be responsible for retrieving an IPTV subscriber's preferences for each IPTV set top box (STB) that is associated with the IPTV subscriber.

In exemplary embodiments, a media encoder server may receive a sequence of images produced by a video processing server and encode the images into live video stream. After that, encoded video may be streamed over the Internet to a set top box via a media distribution system. As a non-limiting example, if the video source is a camera (with live video), a video memory (e.g., an image buffer) may be filled with 5-10 seconds live video. As new video is received in the video memory, the video older than 5-10 seconds may be discarded. Set top boxes can receive the video stream from the buffer. Also, the live video from the camera can be recorded and stored on the network, such that the video can played for subscribers as video on demand (VOD) content. If there is audio involved, only one audio source (which may be multi-audio channels, such as 5.1) is used no matter how many video sources (cameras) are providing input. Exemplary embodiments support both high definition (HD) and standard definition (SD) video.

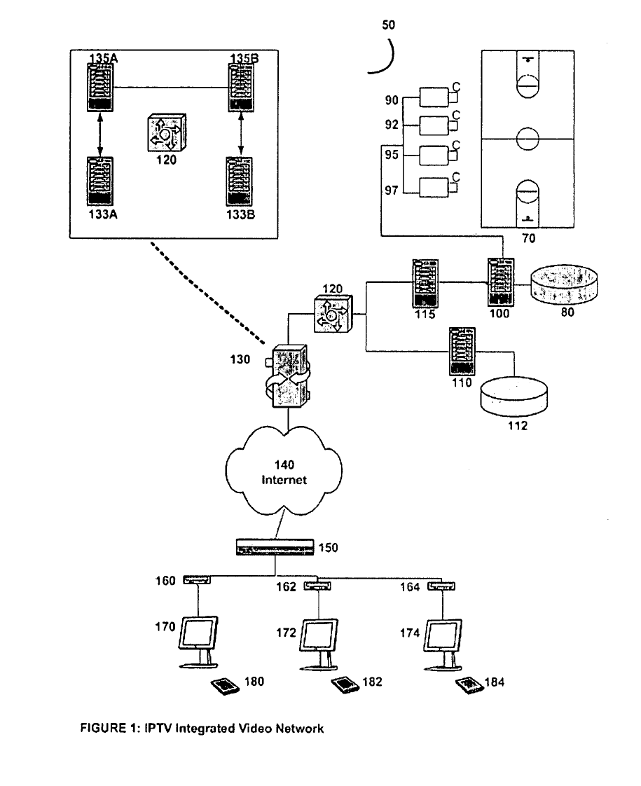

Turning to the drawings in greater detail, it will be seen that FIG. 1 illustrates aspects of a system providing multi-user access of integrated video within an IPTV environment that may be implemented in accordance with exemplary embodiments. As illustrated in FIG. 1, an IPTV system 50 comprises an IPTV gateway 130 that comprises a primary front-end processing system 133A that is in communication with a primary back-end processing system 135A. Tile primary back-end processing system 135A is in further communication with a media distribution system 120. In exemplary embodiments, a redundant secondary front-end 1331B and a secondary back-end processing system 135B are incorporated within the IPTV gateway 130. According to exemplary embodiments, the secondary front-end 133B and back-end 135B processing systems are configured to be operational only in the event of the failure of the primary processing system (133A, 135A) that corresponds to the secondary processing system (133B, 135B).

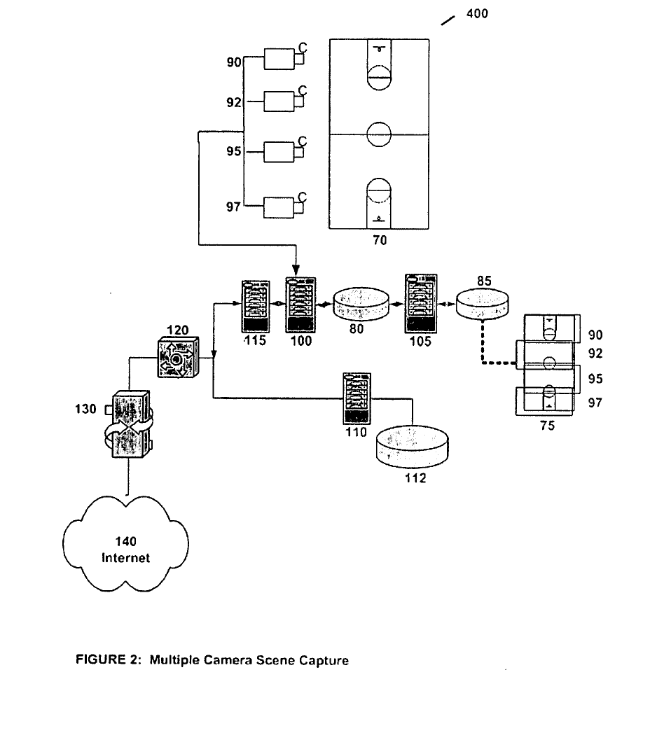

The back-end processing system 135A of the IPTV gateway 130 is interfaced with the media distribution system 120. According to exemplary embodiments, the media distribution system 120 is interfaced with a media encoder server 115 and an IMS component 110. The media distribution system 120 is in further communication with the IPTV gateway 130 which may communicate over the Internet 140 with a media encoder server 150, which communicates with STBs 160, 162, and 164. In accordance with exemplary embodiments, the IMS component 110 is configured to handle the IPTV system performance preferences that have been selected by an IPTV subscriber. The IMS component 110 is operatively coupled to a content database 112 storing television programming and other content. The back-end processing system 135A of the IPTV gateway 130 is also interfaced with a video processor server 100. In operation, the video processor server 100 can be connected to a plurality of video cameras 90, 92, 95 and 97, that are focused on a scene 70, such as a basketball court as illustrated in FIG. 1. Each of the plurality of video cameras 90, 92, 95, 97 may capture a portion of the scene 70 and downloads these images to the video processor server 100, which stores the images to a memory 80. The video processor server 100 processes the images to create one continuous integrated video scene 75 that contains the entire field of view, as illustrated in FIG. 2. As a non-limiting example, the video processor server 100 may receive a plurality of inputs of portions of the scene 70, and a software application (having algorithms) can align the various portions into an integrated video scene, such as the continuous integrated video scene 75. Further, the plurality of inputs may capture the portions of the scene 70 within a particular tolerance so that there is some overlap among the plurality of inputs.

The IPTV system 50 is designed so that a subscriber operating a STB, such as the STB 160, 162, 164, either directly or with a remote control device 180, 182, 184, can request to receive interactive access of the integrated video scene 75. In exemplary embodiments, when the subscriber presses a button on the remote control device 180, the subscriber is given multi-user access to the integrated video scene 75 such that the subscriber can select the portion of the integrated video scene 75 that the subscriber wishes to view, including scenes from the cameras 90, 92, 95 and 97, or some combination thereof. In exemplary embodiments, the scenes may be merged in continuous order to form the integrated video scene 75. The subscriber may have the capability to scroll through the integrated video scene 75 from a portion of the scene captured by the camera 90 to a portion of the scene captured by the camera 92 to a portion of the scene captured by the camera 95 to a portion of the scene captured by the camera 97 and to a portion of the scene captured by the camera 90. Therefore, the subscriber can have up to a 360-degree field of view of the integrated video scene 75. As a non-limiting example, the media encoder server 115 takes in a sequence of images produced by the video processing server 100 and encodes the sequence of images into live video stream. After that, the encoded video is streamed over Internet 140 to the STBs 160, 162, and 164 via media distribution system 120.

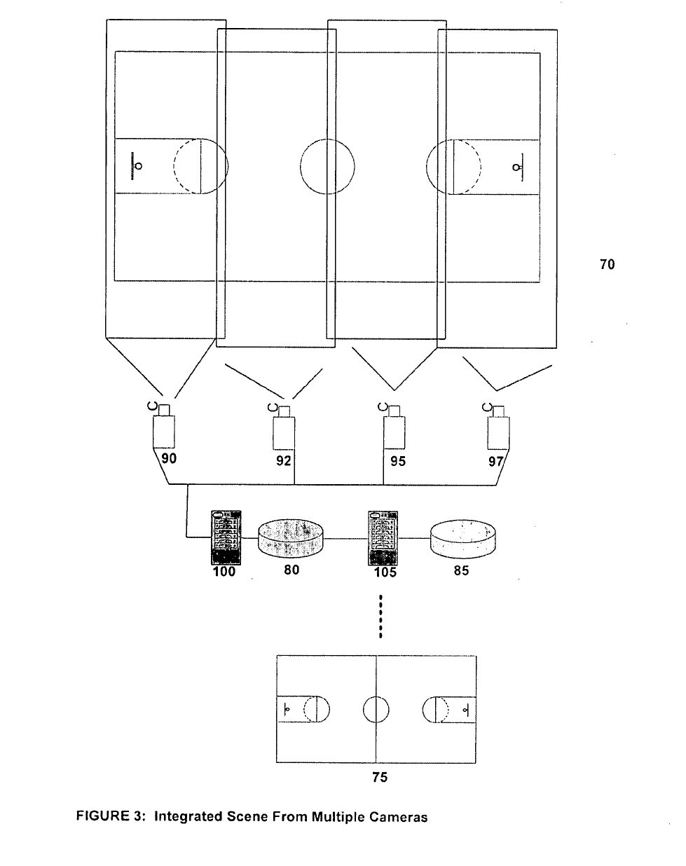

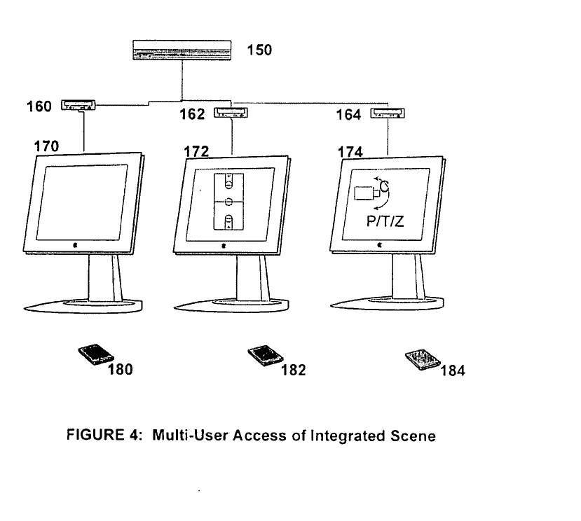

In a further exemplary embodiment, multiple users may access the integrated video scene 75 simultaneously from their individual STBs 160, 162, and 164, as shown in FIG. 4. Each individual subscriber may use his STB 160, 162, and 164 or his remote control 180, 182 and 184 to access the portion of the integrated video scene 75 that the individual subscriber wishes to view as shown on display screens 170, 172 and 174. The individual subscribers may also have the ability to pan, tilt or zoom the portion of the integrated video scene 75 that they are viewing, as shown in the display 174 of Fit. 4. 100261 FIGS. 2 and 3 illustrate the video capture and video processing system in greater detail. In one embodiment, the video cameras 90, 92, 95, and 97 capture the scene 70, such as a basketball court. In an exemplary embodiment, each camera 90, 92, 95, aid 97 captures only a portion of the entire scene 70 (e.g., about 25%), such that each camera has a 90-degree field of view (FOV). However, the FOV may vary depending on the implementation. In this embodiment four cameras are used, however, the number of cameras may vary depending on the needs of the activity or the scene 70 being captured. The video cameras 90, 92, 95, and 97 may also feature multiple lenses for capturing panoramic, three-dimensional or fish eye views of the scene. The types of lens used, number and position of the video cameras 90, 92, 95, and 97 will vary based oil the needs of the user.

As shown in FIGS. 2 and 3, each camera may be connected to a video server, such as the video processor server 100, which downloads the video images to a buffer memory, such as the memory 80. The video processor server 100 may also act as a video processor for processing the images. However, in an exemplary embodiment, a separate video processor 105 may upload the images from the buffer memory 80. The video processor 105 then syncs the images from the cameras 90, 92, 95 and 97 in order to merge the images into the continuous integrated video scene 75. Cameras 90, 92, 95 and 97 continuously capture video; therefore the integrated video scenes 75 continuously grow over time. These integrated video scenes 75 may be stored in the memory 80 and/or a memory 85, for access by the subscribers. Also, the integrated video scene 75 may be provided directly to the subscribers.

Once the integrated video scenes 75 are stored in the memories 80, 85 the scenes may be accessed by a subscriber operating a STB, such as the STB 160. Referring to FIG. 1 the video processor server 100 is in communication with the media distribution system 120. The media distribution system 120 is in further communication with the IPTV gateway 130 which communicates over the Internet 140 with the media encoder server 150. The media encoder server 150 communicates with a plurality of the STBs 160, 162 and 164 owned by a corresponding number of subscribers and( configured to receive IPTV programming.

For each STB 160, 162 and 164 that is configured to receive IPTV programming, the IPTV gateway 130 interacts with an IPTV infrastructure to accomplish the actual transmittal of the IPTV programming to the requesting STB 160, 162 and 164. According to exemplary embodiments, each STB 160, 162 and 164 is connected to a display device, such as the display devices 170, 172 and 174, and can be operated by a remote control device, such as the remote control devices 180, 182 and 184.

FIG. 4 illustrates aspects of a system for multi-user access of the IPTV programming and the integrated video scenes 75. A subscriber operating the STB 160, 162, 164 directly or with a remote 1 80, 182, 184 may access the integrated video 75 of a particular video program. Each subscriber may have the ability to view the portion of the integrated video scene 75 that interests them at any particular moment in time. The subscriber operating the STB 160 may choose to focus on the free throw of the basketball court scene 70, as shown in the display 170. In contrast, the subscriber operating the STB 162 may choose to focus on the entire basketball Court scene 70, as shown in the display 172. The integrated video 75 scene allows the subscribers (i.e., subscriber operating the STB 164) to virtually pan, tilt and zoom the integrated video scene 75 as if they were actually operating the video camera, as shown in the display 174. The subscribers have the ability to scroll thru scenes, virtually panning the camera 360-degrees. Therefore, the subscribers have the ability to view any portion of the integrated video scene 75 at the moment they want to see it.

Illustrated in FIGS. 1, 2 and 4, the integrated video scenes 75 are stored in the memory 80, 85 and are accessible to a subscriber operating the STB 160, 162, 164. The STBs 160, 162 and 164 communicate with the media encoder server 150 to request specific portions of the integrated video scene 75 over the Internet network 140 from the video processor server 100. The integrated video scene 75 is digitally encoded and stored in the memory 80, 85. The video processor server 100 and/or video processor 105 execute algorithms to determine the portion of the integrated video scene 75 that the subscriber is currently viewing. The algorithms also receive input operations from the STBs 160, 162 and 164, which allow the video processor 105 to determine which portion of the integrated video scene 75 that the subscriber would like to view. Additionally, the specific portions of the integrated video scene 75 may have identifying information that is unique to each specific portion of the integrated video scene 75 that the subscriber is currently viewing and/or has requested to view. In an exemplary embodiment, the integrated video scene 75 is digital code that can be manipulated in a variety of ways. According to exemplary embodiments, the algorithms determine if the subscriber desires to zoom, pan and/or tilt a portion of the integrated video scene 75. Other algorithms manipulate the digital code so that the integrated video scene 75 provides virtual scrolling, zoom, pan and tilt operations. The algorithms further allow a plurality of input operations from a corresponding plurality of subscribers wishing to individually view and/or manipulate the particular portion of the integrated video scene 75 of their choosing. In an exemplary embodiment, the video processor server 100, video processor 105, and memory 80, 85 are robust enough and have enough bandwidth to simultaneously process inputs from millions of subscribers. To accomplish this teat the IP TV system 50 and an integrated video processing system 400 illustrated in FIGS. 1 and 2 respectively, may include a plurality of the video servers 100, video processors 105, and memories 80, 85. Other components in the systems 50, 400 may be duplicated as well to handle the demands of the subscribers.

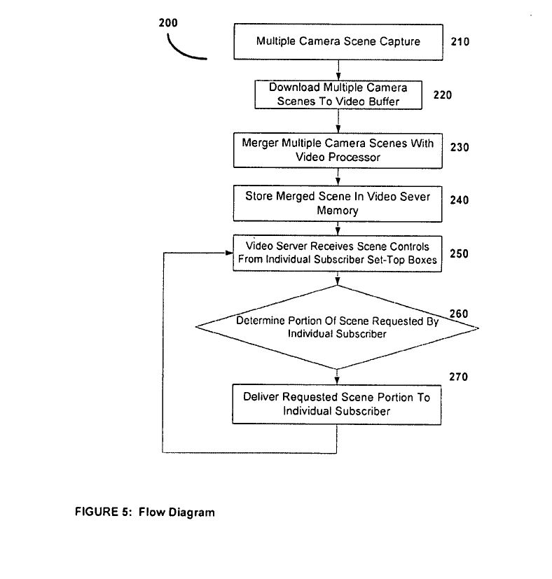

FIG. 5 discloses one embodiment of a methodology 200 for supplying the integrated video scene 75 to a subscriber. Multiple cameras, such as the cameras 90, 92, 95, and 97, capture the scene at step 210. The video images are downloaded to a video buffer, such as the memory 80 at step 220. A video processor, such as the video processor server 100, gathers, syncs and merges the scenes into a continuous integrated video, such as the integrated video scene 75 at step 230 and stores the scenes in the memory 80 at step 240. The scenes remain stored in the memory 80 to allow a subscriber access to the scenes via a STB, such as the STB 160, 162, 164. The video processor server 100 receives the operational request for the scenes from the subscriber STBs 160, 162 and 164 at step 250. The video processor server 100 determines the portion of the integrated video scenes 75 that the subscriber wishes to view it step 260. This determination allows the video processor server 100 to stream the requested portion of the integrated video scene 75 to the subscriber at step 270. The subscriber also has the ability to pan, tilt or zoom to the portion of the integrated video scene 75 of interest. Typically the system will stay at the level of pan, tilt or zoom the subscriber selects until, the subscriber chooses to changes it.

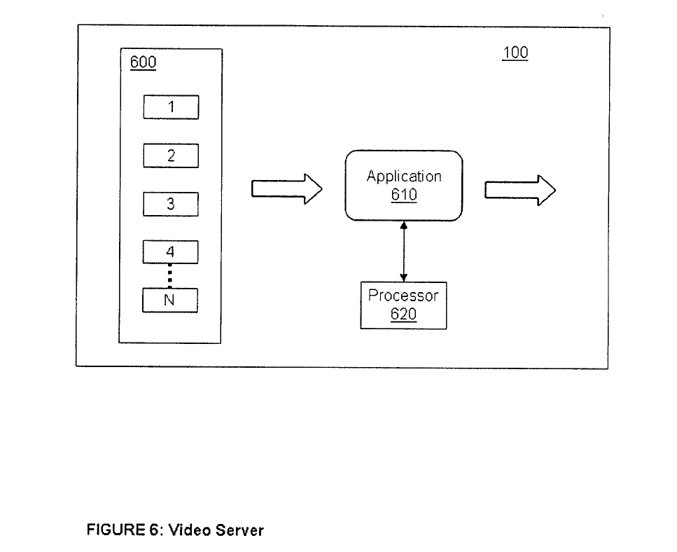

As a non-limiting example, FIG. 6 illustrates a plurality of portions 600 (e.g., portions 1-N each representing a different part of the larger scene, such as the basketball court scene 70) received by the video processor server 100 in accordance with exemplary embodiments. The plurality of portions 600 are received from a plurality of video cameras, such as the cameras 90, 92, 95, 97 (it is understood that the plurality of video cameras are not limited to four cameras on one side of the basketball court scene 70 as shown in FIGS. 1, 2, and 3). Portions of the plurality of portions 600 may overlap with other portions of the plurality of portions 600 such that a 360-degree field of view is provided of the basketball court scene 70. Also, the plurality of video cameras may surround the basketball Court scene 70, and each camera may be located at various positions and have various degrees of pan, tilt, or zoom. As a non-limiting example, if there is a particular portion of the plurality of portions 600 that a subscriber desires to view, the subscriber may select a view from any of the plurality of portions 600.

In accordance with exemplary embodiments, a video integration application 610 receives the plurality of portions 600, and a processor 620 processes instructions of the video integration application 610. The video integration application 610 integrates the plurality of portions 600 to form the integrated video scene 75. As a non-limiting example, the video integration application 610 may detect the overlap among the plurality of portions 600 and combine the plurality of portions 600 accordingly. As a non-limiting example, the video integration application 610 may detect certain background information and combine the plurality of portions 600 accordingly. Also, the video integration application 610 may combine the plurality of portions 600 based on the specific location of each of the plurality of video cameras. Furthermore, the techniques for integrating the plurality of portions 600 is not meant to be limiting, and it is understood that the video integration application 610 can merge the plurality of portions 600 according to any techniques that may be well known in the art. When the plurality of portions 600 are integrated into the integrated video scene 75, the integration application 610 can pan, tile, and/or zoom in on any view of the integrated video scene 75 even l the view is not within in single a portion of the plurality of portions 600, as long as the view is obtainable from the combined portions of the plurality of portions 600.

As discussed herein, subscribers can make request via the remote control device 180, 182, 184. By way of examples and not limitations, subscribers may go to a menu that has various items of functionality to select from for adjusting the appearance of the integrated video scene 75. Also, the various items of functionality may be initiated by pressing a button on the remote control device 180, 182, 184. Subscribers also may select and highlight areas on the display 170, 172, 174 similar to making selections and highlighting using a mouse on a computer.

In exemplary embodiments, a subscriber may scroll (or pan) through various scenes of the integrated video scene 75 using the remote control device 180, 182, 184. As a non-limiting example, the subscriber may select a scene (e.g., by highlighting a desired area of the scene with the remote control device 180, 182, 184) and choose to zoom in on that area. The video integration application 610 can zoom in or out on the area as close or far as the corresponding individual portion or combined portions of the plurality of portions 600 is able to show, which is based on the plurality of video cameras. Although the previous non-limiting example is related to zoom capabilities, similar functionality is available for tilt and pan. The desired functionality, such as tilt, pan, and zoom, is received as requests by video processor server 100, and the requests are in accordance with the various selections and/or highlighting of the subscriber. The requests are transmitted by the STBs 160, 162, 164, which each may have a unique identification (such as an IP address).

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the compute- program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for distributing a continuous integrated video to a plurality of subscribers via an IPTV network, the method comprising:
receiving input from a plurality of cameras, each camera focused on a portion of a larger scene and each camera capturing its portion of the larger scene;
storing in a memory of a video processor, each camera's captured portion of the larger scene;
executing in the video processor and a buffer memory a process for merging each camera's captured portion of the larger scene into a continuous integrated video;
storing the continuous integrated video in a memory of-a video server;
communicating between the video server and a set-top box via the IPTV network, wherein the set-top box is operable over the IPTV network and wherein the set-top box is connected to a display device and operated by a subscriber;
receiving at the video server, inputs from the set-top box operated by the subscriber for viewing specific portions of the continuous integrated video; and
streaming the requested portion of the continuous integrated video from the buffer memory to the set-top box in accordance with the subscriber's inputs.

2. The method of claim 1, wherein the video processor stores the continuous integrated video in a separate buffer and streams the continuous integrated video to the subscriber's set-top box.

3. The method of claim 2, wherein the video server receives inputs from the subscriber to scroll, pan, tilt or zoom a portion of the continuous integrated video;
wherein the video processor executes algorithms to manipulate the continuous integrated video to create a virtual scroll, pan, tilt or zoom effect; and
wherein the video processor streams the manipulated portion of the continuous integrated video to the subscriber's set-top box.

4. The method of claim 1, wherein the plurality of cameras include cameras with multiple lenses for capturing a global view of the scene.

5. The method of claim 1, wherein the video processor streams a plurality of individual viewpoints of the continuous integrated video to a corresponding plurality of individual subscribers based on the plurality of individual subscriber's operation of their set-top boxes.

6. The method of claim 1, wherein the plurality of cameras include foul cameras each covering a ninety degree field-of-view, such that all four cameras cover a 360 degree field-of-view.

7. The method of claim 6, wherein the set-top box is connected to a display device, wherein the display device includes at least one of a television, cell phone, personal digital assistant, and personal computer.

8. A system for providing a continuous integrated video via an IPTV network, the system comprising:
a video processor that receives inputs from a plurality of cameras, each camera focused on a portion of a scene and each camera capturing its portion of the scene,
wherein the video processor has a memory for storing each camera's captured portion of the scene, the video processor being operative to merge each camera's captured portion of the scene into the continuous integrated video, such that the continuous integrated video contains the entire scene and stores the continuous integrated video in a buffer memory; and
a video server connected to the memory of the video processor, the video server operative to:
receive inputs from a set-top box for viewing specific portions of the continuous integrated video, and
stream the requested portion of the continuous integrated video from the memory to the set-top box in accordance with the received inputs from the set-top box.

9. The system of claim 8, wherein the video processor stores the continuous integrated video in a separate buffer and streams scenes to the set-top box.

10. The system of claim 9, wherein the video server receives inputs from the subscriber to scroll, pan, tilt, or zoom a portion of the continuous integrated video; and
wherein the video processor executes algorithms to manipulate the continuous integrated video to create a virtual scroll, pan, tilt or zoom effect and streams the manipulated continuous integrated video via the video server to the set-top box.

11. The system of claim 8, wherein the plurality of cameras include cameras with multiple lenses for capturing a global view of the scene.

12. The system of claim 8, wherein the video processor streams a plurality of individual viewpoints of the continuous integrated video to a corresponding plurality of individual set-top boxes based on operation of the plurality of individual set-top boxes.

13. The system of claim 8, wherein the plurality of cameras include four cameras each covering a ninety degree field-of-view, such that all four cameras cover a 360 degree field-of-view.

14. The system of claim 13, wherein the set-top box is connected to a display device, wherein the display device includes at least one of a television, cell phone, personal digital assistant, and personal computer.

15. A computer program product that includes a computer readable medium useable by a processor, the medium having stored thereon a sequence of instructions which, when executed by the processor, causes the processor to deliver continuous integrated video via an IPTV network to a display device by:
retrieving a plurality of images captured by a sequence of video cameras, the plurality of images including a plurality of portions of a panoramic scene in a field-of-view of the sequence of video cameras;
processing the plurality of images captured by the sequence of video cameras so that the plurality of images are merged into a continuous integrated video that provides the panoramic scene in the field-of-view of the sequence of video cameras;
processing the merged continuous integrated video to allow at least one of a virtual pan, a tilt, and a zoom of a portion of the merged continuous integrated video; and
streaming the at least one of the pan, tilt, and zoom portion of the merged continuous integrated video in accordance with signals received from a set-top box.

16. The computer program product of claim 15, wherein signals are received from a plurality of set-top boxes operated by a corresponding plurality of subscribers, each subscriber operating the corresponding one of the plurality of set-top boxes to view portions of the integrated video of their choice.

17. The computer program product of claim 16, wherein the sequence of cameras includes four cameras, each camera covering a ninety degree field-of-view, such that the combination of all four cameras covers an entire 360 degree field-of-view.

18. The computer program product of claim 15, wherein the set-top box is connected to a display device, wherein the display device includes at least one of a television, cell phone, personal digital assistant, and personal computer.

19. The computer program product of claim 15, wherein the plurality of images retrieved from the sequence of video cameras are initially stored on respective buffers of the sequence of video cameras.

20. The computer program product of claim 19, wherein the plurality of images are merged into one continuous integrated video by merging the images in sequence from left to right or from right to left to create an entire 360 degree field of view.
